(19) United States
(12) Patent Application Publication
(10) Pub. No.: US 2025/0193301 A1
(43) Pub. Date: Jun. 12, 2025

(54) DISPLAY MODULES AND MOBILE TERMINALS

(71) Applicant: Wuhan China Star Optoelectronics Semiconductor Display Technology Co., Ltd., Wuhan, Hubei (CN)

(72) Inventor: Yanqiang DUAN, Wuhan, Hubei (CN)

(73) Assignee: Wuhan China Star Optoelectronics Semiconductor Display Technology Co., Ltd., Wuhan, Hubei (CN)

(21) Appl. No.: 18/279,609

(22) PCT Filed: Jun. 13, 2023
(86) PCT No.: PCT/CN2023/099908

§ 371 Date: Feb. 6, 2025

(30) Foreign Application Priority Data
Jun. 6, 2023 (CN) 202310667697.7

(51) Int. Cl. H04M 1/02

(52) U.S. Cl. CPC H04M 1/0269

(57) ABSTRACT

Disclosed are a display module and a mobile terminal, the display module including: a display panel including a first body, a bent part, and a second body; a protection layer including a first protection part, a second protection part, and a bending protection part. The first protection part covers a part of the first body, the second protection part covers a part of the second body, and the bending protection part covers the curved part. A bending stiffness of the bending protection part close to the first protection part is less than that of the bending protection part close to the second protection part.

### TECHNICAL FIELD

The present disclosure relates to the field of display, and in particular, to a display module and a mobile terminal.

### BACKGROUND

With the development trend of electronic devices pursuing ultimate full-screens, the display screens (for example, used for mobile phones) are continuously emerging in the market. To pursue the diversification of the appearance of the display device, the cover of the display screen has been developed from the double-curved surfaces on the left and right sides to the four-side curved surfaces or the fully-curved form.

During attaching the fully-curved display screen, the higher the curvature thereof, the greater the tensile stress to be applied to the bent portion of the display screen, especially in the bent areas on two sides of the screen. There are two bending forces which are perpendicular to each other along the bending axis in the region, so that a bending radius of a side of the bent area close to the cover becomes smaller. The special-shaped bending can cause the internal circuit of the panel to be broken, resulting in abnormal display of the display screen.

### SUMMARY

The present disclosure provides a display module and a mobile terminal to solve the technical problem of special-shaped bending of a bent portion in a bent region on two sides of an existing fully-curved display module.

To solve the above problem, the present disclosure provides the following the technical solutions.

The present disclosure provides a display module including:
a display panel including a first body, a second body, and a bent part disposed between the first body and the second body, the second body being disposed on a side away from a light-outgoing surface of the display panel;
a cover disposed on the display panel, the cover including a first curved part corresponding to the bent part, the first curved part including a first curved section and second curved sections located at two sides of the first curved section, a minimum bending curvature of the first curved section being less than or equal to a maximum bending curvature of the second curved sections, and the bending curvature of the second curved sections being greater than 0; and
a protection layer disposed on a surface of the display panel, the protection layer including a first protection part, a second protection part, and a bending protection part in a continuous arrangement, the first protection part covering a part of the first body, the second protection part covering a part of the second body, and the bending protection part covering the bent part;
wherein a bending stiffness of the bending protection part close to the first protection part is less than that of the bending protection part close to the second protection part.

The present disclosure further provides a mobile terminal, including a terminal body and a display module integrated with each other, wherein the display module includes:
a display panel including a first body, a second body, and a bent part disposed between the first body and the second body, the second body being disposed on a side away from a light-emitting surface of the display panel;
a cover disposed on the display panel, the cover including a first curved part corresponding to the bent part, the first curved part including a first curved section and second curved sections located at two sides of the first curved section, a minimum bending curvature of the first curved section being less than or equal to a maximum bending curvature of the second curved sections, and the bending curvature of the second curved sections being greater than 0; and
a protection layer disposed on a surface of the display panel, the protection layer including a first protection part, a second protection part, and a bending protection part in a continuous arrangement, the first protection part covering a part of the first body, the second protection part covering a part of the second body, and the bending protection part covering the bent part;
wherein a bending stiffness of the bending protection part close to the first protection part is less than that of the bending protection part close to the second protection part.

### BRIEF DESCRIPTION OF THE DRAWINGS

FIG. 1 is a top view of an existing fully curved display screen in which a curved surface is attached on a side away from a light-outgoing surface.

FIG. 2 shows a structure of a cover of an existing fully curved display screen.

FIG. 3 is a schematic cross-sectional view of a bent part of an existing fully curved display screen.

FIG. 4 is a schematic top view of a display module according to an embodiment of the present disclosure.

FIG. 5 is a schematic graph of a radius of curvature of a first structure of a cover along the section ZZ of FIG. 4.

FIG. 6 is a schematic graph of a radius of curvature of a second structure of a cover along the section ZZ of FIG. 4.

FIG. 7 is a schematic cross-sectional view of the section WW of FIG. 4.

FIG. 8 is a schematic diagram of a film layer structure of a display module according to an embodiment of the present disclosure.

FIG. 9 is a schematic cross-sectional view of a display module without being bent according to an embodiment of the present disclosure.

FIG. 10 is a schematic top view of a first structure of a display module without being bent according to an embodiment of the present disclosure.

FIG. 11 is a graph of a thickness distribution of a side of a second protection layer close to an adhesive layer in a display module according to an embodiment of the present disclosure.

FIG. 12 is a schematic cross-sectional view of section MM1 of FIG. 11.

FIG. 13 is a schematic cross-sectional view of section MM2 of FIG. 11.

FIG. 14 is a schematic cross-sectional view of section MM3 of FIG. 11.

FIG. 15 is a schematic top view of a display module of a second structure without being bent according to an embodiment of the present disclosure.

### DETAILED DESCRIPTION OF THE EMBODIMENTS

The present disclosure will be described in detail with reference to the accompanying drawings and examples to make the objective, technical solutions, and effects thereof clear and explicit. It is to be understood that the specific embodiments described herein are merely illustrative and are not intended to limit the present disclosure.

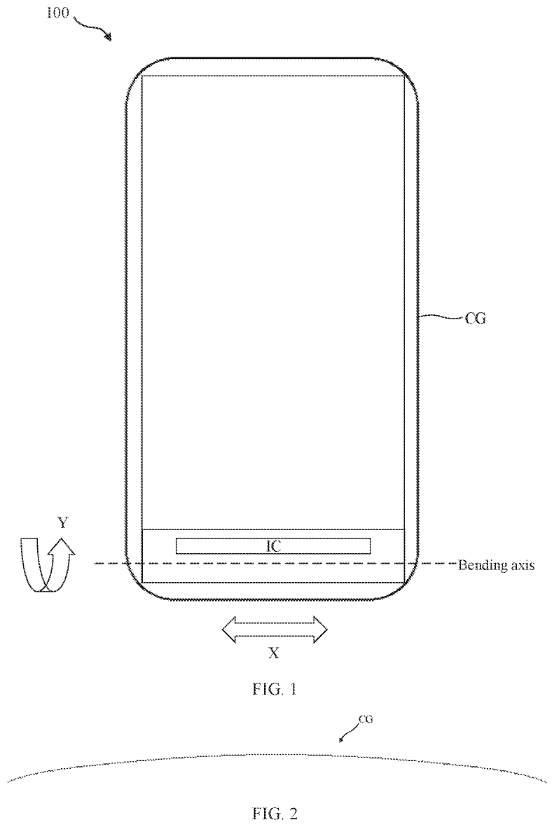

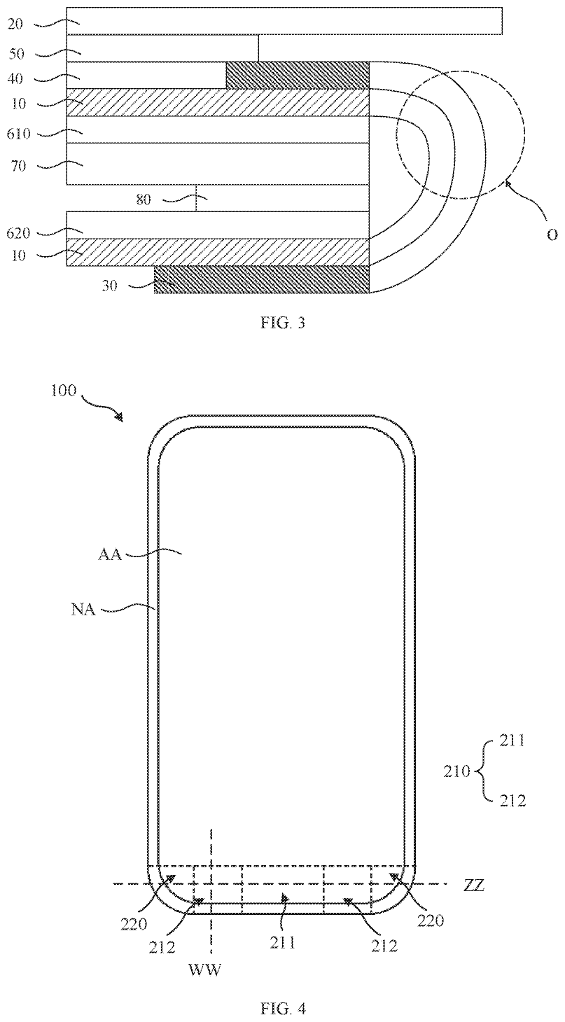

FIG. 1 is a top view of a fully curved display screen in which a curved surface is attached on a side away from a light-outgoing surface. FIG. 2 shows a structure of a fully curved cover CG, that is, the cover CG is in a bent state at any position. The higher a curvature thereof, the greater a tensile stress to be applied to a bent display panel 10, especially in bent regions on two sides of the display panel 10. There are two bending forces (i.e., forces in directions X and Y) perpendicular to each other along a bending axis at that region, so that a bending radius of a side of the bent region close to the cover in this region becomes smaller, for example, a structure as shown in FIG. 3. This special-shaped bending causes the display panel 10 in the region O to be inclined toward the cover 20, so that internal lines of the display panel 10 may be broken, resulting in display abnormality of the display panel 10.

Referring to FIGS. 4 to 11, an embodiment of the present disclosure provides a display module 100, including a display panel 10, a cover 20 on the display panel 10, and a protection layer 30 on a surface of the display panel 10.

In the embodiment, the display panel 10 may be a flexible display panel 10. The display panel 10 may include a first body 110, a second body 120, and a bent part 130 disposed between the first body 110 and the second body 120. The second body 120 is disposed on a side away from a light-outgoing surface of the display panel 10.

In the embodiment, the cover 20 includes a first curved part 210 corresponding to the bent part 130. The first curved part 210 includes a first curved section 211 and second curved sections 212 located on two sides of the first curved section 211. A minimum bending curvature of the first curved section 211 is less than or equal to a maximum bending curvature of the second curved sections 212. The bending curvature of the second curved sections 212 is greater than 0.

In the embodiment, the protection layer 30 includes a first protection part 310, a second protection part 320, and a bending protection part 330 in a continuous arrangement. The first protection part 310 covers a part of the first body 110, the second protection part 320 covers a part of the second body 120, and the bending protection part 330 covers the bent part 130. A bending stiffness of the bending protection part 330 close to the first protection part 310 is less than that of the bending protection part 330 close to the second protection part 320.

It is to be noted that in a structure as shown in FIG. 4, the cover 20 includes two second curved parts 220 located on both sides of the first curved part 210. The second curved parts 220 do not correspond to the bent part 130. That is, the bent part 130 of the display panel 10 does not overlap the second curved part 220 in a top view direction of the display panel 10. The second curved parts 220 and the second curved sections 212 are continuously arranged. A minimum bending curvature of the second curved parts 220 is greater than the maximum bending curvature of the second curved parts 212. Since the bent part 130 does not overlap the second curved part 220, the bending of the second curved parts 220 of the present disclosure does not exert a force in a corresponding direction on the bent part 130. The special-shaped bending of the bent part 130 primarily results from a change in the bending curvature of the second curved sections 212.

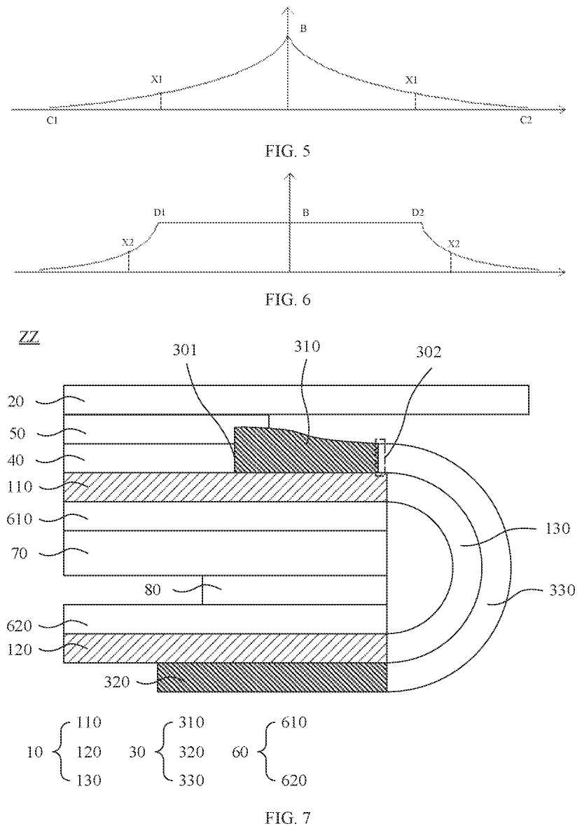

It is to be noted that, the variation of a radius of curvature of the cover 20 along section ZZ of FIG. 4 may be shown in FIGS. 5 and 6, in which the reciprocal of the radius of curvature is a bending curvature. The following will be described in terms of the radius of curvature. In a structure as shown in FIG. 5, the cover 20 has a maximum radius of curvature at point B, i.e., the axis of the cover 20. The radius of curvature thereof gradually decreases in a direction from point B to the points C1 and C2 of the cover 20. In a structure as shown in FIG. 6, the cover 20 has a constant radius of curvature in a direction from point B to the points D1 and D2, at which inflection points occur, and then the radius of curvature gradually decreases. In the variation of the radius of curvature of FIGS. 5 and 6, when the radius of curvature decreases to a certain value, for example, at points X1 of FIG. 5 or points X2 of FIG. 6, the bending forces along both the X-direction and the Y-direction at that positions causes the bent part 130 of the display panel 10 to be deflected toward the cover 20, thereby generating a special-shaped bending. As the radius of curvature decreases further, the deflection of the bent part 130 toward the cover 20 becomes more serious.

Therefore, according to the present disclosure, the bending stiffness of the bending protection part 330 close to the first protection part 310 is set to be less than that of the bending protection part 330 close to the second protection part 320. In this case, the decrease in the bending stiffness of the bending protection part 330 close to the first protection part 310 allows the bent part 130 at this region to be more easily bent, and the increase in the bending stiffness of the bending protection part 330 close to the second protection part 320 improves the supporting force on the bent part 130 at that region, which facilitates the curved corners of the bent part 130 to be rounded, thereby alleviating the shape abnormality of a side of the bent part 130 close to the cover 20, improving the force uniformity to which the bent part 130 is subjected, and reducing the risk of line breakage in the display panel 10.

The technical solutions of the present disclosure will now be described in connection with specific embodiments.

Referring to FIG. 4, the display module 100 includes a display area AA and a non-display area NA disposed close to the display area AA. Optionally, the non-display area NA surrounds the display area AA so that the display area AA is encircled by the non-display area NA. The display area AA is an area of the display module 100 that is used for performing a display function, and includes a plurality of display units for performing the display function. The non-display area NA may be a frame region of the display module 100, and has a functional component for assisting the display of the display units of the display area AA inside.

In the present embodiment, referring to FIG. 7, it is a cross-sectional view of section WW of FIG. 4, and the section WW may be any cross-section of a lower frame region of the display module. The display module 100 may include the display panel 10, a polarizer 40 disposed on the display panel 10, an optical glue layer 50 disposed on the polarizer 40, and the cover 20 disposed on the optical glue layer 50.

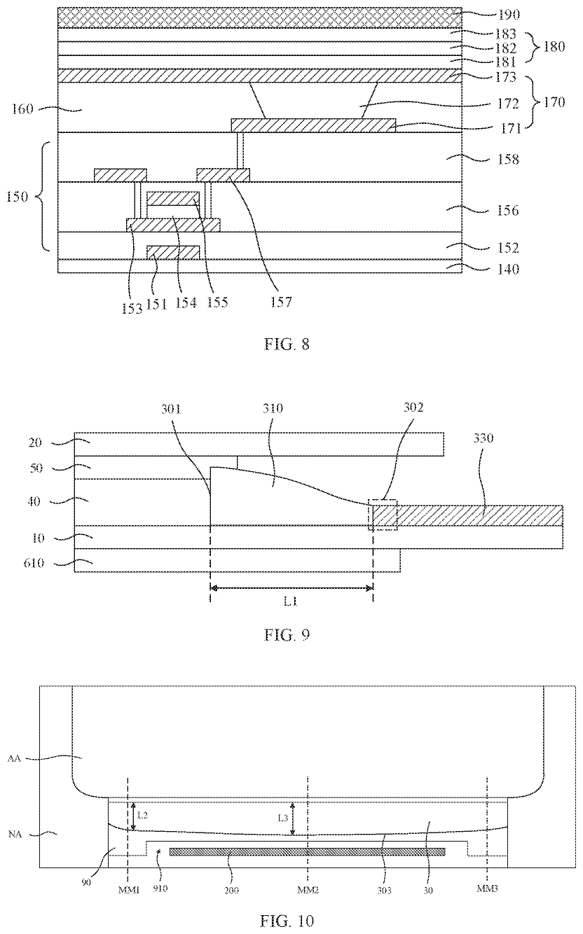

In the present embodiment, referring to FIG. 8, the display panel 10 may include a base substrate 140, a drive circuit layer 150 disposed on the base substrate 140, a pixel definition layer 160 and a light-emitting element layer 170 disposed on the drive circuit layer 150, an encapsulation layer 180 disposed on the pixel definition layer 160, and a touch layer 190 disposed on the encapsulation layer 180.

In the present embodiment, the base substrate 140 supports each layer disposed on the base substrate 140. When the display panel 10 is a bottom light-emitting display device or a double-side light-emitting display device, a transparent base substrate is used. When the display panel 10 is a top light-emitting display device, a translucent or opaque base substrate and a transparent base substrate may be used.

In the present embodiment, the base substrate 140 is made of an insulating material such as glass, quartz, or a polymer resin. The base substrate 140 may be a rigid substrate, a flexible substrate that may be bent, folded, crimped, or the like. An example of flexible materials of the flexible substrate includes, but is not limited to, polyimide (PI).

In the present embodiment, referring to FIG. 8, the drive circuit layer 150 may include a plurality of thin film transistors. The thin film transistors may be of etch-blocking type, back-channel etching type, or may be divided into bottom-gate thin film transistors, top-gate thin film transistors, or the like according to the positions of the gate and the active layer, without special limitation. For example, the thin film transistor shown in FIG. 6 is a top-gate thin film transistor that may include a light shielding layer 151 disposed on a substrate, a buffer layer 152 disposed on the light shielding layer 151, an active layer 153 disposed on the buffer layer 152, a gate insulating layer 154 disposed on the active layer 153, a gate layer 155 disposed on the gate insulating layer 154, an interlayer insulating layer 156 disposed on the gate layer 155, a source-drain layer 157 disposed on the interlayer insulating layer 156, and a flat layer 158 disposed on the source-drain layer 157. In the present embodiment, the interlayer insulating layer 156 may be laid down as a whole layer, or formed in the same photomask process as the gate layer 155 as the structure of FIG. 8. The structure of the thin-film transistor of FIG. 8 is only one example of the present disclosure, and other types of thin film transistors are also applicable to the present disclosure.

In the present embodiment, referring to FIG. 8, the light-emitting element layer 170 may further include an anode layer 171 disposed on the flat layer 158, a light-emitting layer 172 disposed on the anode layer 171, and a cathode layer 173 disposed on the light-emitting layer 172. The anode layer 171 includes a plurality of anodes, the pixel definition layer 160 includes a plurality of pixel openings corresponding to the plurality of anodes one-to-one, and each of the pixel openings exposes an upper surface of the corresponding anode. The light-emitting layer may include a plurality of light-emitting pixels corresponding to the plurality of anodes one-to-one.

In the present embodiment, referring to FIG. 8, the encapsulation layer 180 covers the pixel definition layer 160 and successively covers the plurality of pixel openings and the plurality of light-emitting pixels. The encapsulation layer 180 may include at least a first inorganic encapsulation layer 181, a first organic encapsulation layer 182, and a second inorganic encapsulation layer 183 stacked on the pixel definition layer 160.

In the present embodiment, referring to FIG. 8, the touch layer 190 may include a first touch metal layer and a second touch metal layer disposed on the encapsulation layer 180, and an insulating layer disposed between the first touch metal layer and the second touch metal layer. The touch layer 190 according to the embodiment of the present disclosure may be of a self-capacitance type or a mutual-capacitance type, and the specific type and structure of the touch layer 190 may be selected according to actual requirements.

In the present embodiment, the polarizer 40 may be disposed above the touch layer 190, without special limitations.

In the present embodiment, referring to FIG. 7, the display module 100 further includes a back plate layer 60. The back plate layer 60 includes a first back plate 610 and a second back plate 620 disposed separately from each other. The first back plate 610 and the second back plate 620 are disposed between the first body 110 and the second body 120. The first back plate 610 is disposed on a side of the first body 110 away from a light-outgoing surface thereof, and bonded to the first body 110 by a glue layer. The second back plate 620 is disposed on a side of the second body 120 close to a light-outgoing surface thereof, and bonded to the second body 120 by a glue layer. That is, the first back plate 610 and the second back plate 620 are disposed between the first body 110 and the second body 120.

In the present embodiment, referring to FIG. 7, the display module 100 further includes a first support layer 70 and a second support layer 80 disposed between the first back plate 610 and the second back plate 620. The first support layer 70 is bonded to the first back plate 610 by a glue layer, and the second support layer 80 is bonded to the second back plate 620 by a glue layer. A material of the first support layer 70 may be stainless steel, and a material of the second support layer 80 may be foam, polyethylene terephthalate (PET), or the like.

In the present embodiment, referring to FIG. 7, the display module 100 may further include the protection layer 30 disposed on the display panel 10. The protection layer 30 covers the bent part 130 and a part of the first body 110 and the second body 120. The first protection part 310 covers a part of the first body 110, the second protection part 320 covers a part of the second body 120, and the bending protection part 330 covers the bent part 130.

The protection layer 30 is mainly used to protect a metal line in the display panel 10 so that the metal line is insulated from water and oxygen. However, in the existing art, a region immediately close to the polarizer 40 is coated with more material of the protection layer 30 so that the protection layer 30 can be arranged immediately close to the polarizer 40. This arrangement may cause the material of the protection layer 30 on the bent part 130 close to the first body 110 to be more than that on the bent part 130 away from the first body 110, so that the bending stiffness of the bending protection part 330 close to the first protection part 310 is increased, thereby increasing the flexural strength of the bent part 130 corresponding to the bending protection part 330, and decreasing the bending radius of a side of the bent part 130 close to the cover 20 at that region to form abnormal bending.

In the display module 100 of the present disclosure, in the direction from the first protection part 310 to the second protection part 320, the thickness of the first protection part 310 gradually decreases, and the bending protection part 330 has the same thickness at any position on a side close to the first protection part 310.

In the present embodiment, referring to FIGS. 7 and 9, the thickness of the first protecting part 310 gradually decreases in the direction away from the polarizer 40. The bending protecting part 330 has the same thickness at a side close to the first protecting part 310. Alternatively, for example, in a structure of FIG. 7, the thickness of the bending protecting part 330 is equal at any position, and in a region close to the bent part 130, the thickness of the first protecting part 310 may be equal to that of the bending protecting part 330. Since the first protection part 310 is in contact with the polarizer 40, the material of the protection layer 30 close to the polarizer 40 in the first protection part 310 has a maximum thickness.

In the present embodiment, according to the present disclosure, the distance between the edge of the polarizer 40 close to the bent part 130 and the edge of the first back plate 610 close to the bent part 130 is controlled so that the material of the protection layer 30 is leveled within the distance, so as to retain an area with an uneven thickness of the protection layer 30 in the first protection part 310. The thickness of the first protection part 310 close to the bending protection part 330 is equal to the thickness of the bending protection part 330, so that the thickness of the bending protection part 330 is equal at any position, reducing the bending stiffness of the bending protection part 330 close to the first protection part 310, resulting in more easy bending of the bent part 130 corresponding to the bending protection part 330, facilitating the curved corners of the bent part 130 to be rounded, relieving the shape abnormality of a side of the bent part 130 close to the cover 20, improving the stress uniformity on the bent part 130, and reducing the risk of line breakage in the display panel 10.

In the display module 100 of the present disclosure, referring to FIGS. 7 and 9, the thickness of a side of the first protection part 310 away from the bending protection part 330 may be greater than that of the polarizer 40. In order to dispose the protection layer 30 immediately close to the polarizer 40, and to retain the material of the protection layer 30 on the first body 110 as much as possible, the thickness of a side of the first protection part 310 close to the polarizer 40 is set to be maximum. In addition, in order to avoid exposure of a side surface of the polarizer 40, the thickness of the first protection part 310 needs to be greater than the thickness of the polarizer 40, so that the side surface of the polarizer 40 may be completely covered by the first protection part 310.

In the display module 100 of the present disclosure, referring to FIGS. 7 and 9, the display module 100 further includes the optical glue layer 50 disposed between the polarizer 40 and the cover 20. The optical glue layer 50 covers the polarizer 40 and extends between the protection layer 30 and the cover 20. The optical glue layer 50 serves to bond the polarizer 40 and the cover 20.

In the present embodiment, the thickness of the optical glue layer 50 corresponding to the polarizer 40 may be greater than the thickness of the optical glue layer 50 corresponding to the protection layer 30. In order to avoid the side surface of the polarizer 40 to be exposed, the thickness of the first protection part 310 needs to be greater than the thickness of the polarizer 40, so that the first protection part 310 may completely cover the side surface of the polarizer 40. In addition, in order to avoid excessive overhang area between the cover 20 and the protection layer 30, which may cause the cover 20 to press down towards the display panel 10, the optical glue layer 50 will extend toward between the protection layer 30 and the cover 20, and cover a part of the first protection part 310.

In the display module 100 of the present disclosure, referring to FIGS. 7 and 9, the bending protection part 330 includes a first end 302 close to the first protection part 310. The first end 302 has the same thickness at any position. An orthographic projection of the first end 302 on the back plate layer 60 is located in the first back plate 610.

In the present embodiment, since the start position of the bending of the display panel 10 is determined according to the position of the end surface of the first back plate 610, and it is desired to ensure uniform distribution of the thickness of the protection layer 30 on the bent part 130, the first end 302 of the first protection part 310 and the bending protection part 330 needs to be retracted toward the display area AA relative to the end surface of the first back plate 610. That is, the orthographic projection of the first end 302 of the first protection part 310 and the bending protection part 330 on the back plate layer 60 is located in the first back plate 610, so that at least part of the bending protection part 330 and the first back plate 610 are overlapped, and the thickness of the protection layer 30 on the bent part 130 is uniformly distributed.

In the display module 100 of the present disclosure, referring to FIG. 9, a distance L1 between a first interface 301 and the first end 302 may be greater than or equal to 250 μm and less than or equal to 500 μm.

In the present embodiment, since the distance L1 between the first interface 301 and the first end 302 is in a range of 250 μm to 500 μm, a distance between the first interface 301 and the end surface of the first back plate 610 needs to be greater than the distance L1 between the first interface 301 and the first end 302.

In the present embodiment, the thickness of the first protection part 310 gradually decreases in the direction from the first protection part 310 to the second protection part 320, and the material of the protection layer 30 needs a certain leveling distance. If the distance between the edge of the polarizer 40 and the edge of the first back plate 610 is too low, the leveling distance will fall within the bent part 130, so that the bending protection part 330 has an uneven thickness. Therefore, in the present disclosure, the distance between the first interface 301 and the end surface of the first back plate 610 is controlled to ensure smooth transition from the first protection part 310 toward the bending protection part 330, and to avoid the risk of flow of the material of the first protection part 310 to the bending protection part 330. A maximum value of the distance L1 between the first interface 301 and the first end 302 is 500 μm. Although the increase of the distance ensures the smooth transition from the first protection part 310 to the bending protection part 330, it increases the width of the non-display area NA of the display panel 10, which is disadvantageous in the design of narrow frame.

In the display module 100 of the present disclosure, referring to FIGS. 10 to 15, the display module 100 further includes an adhesive layer 90 in contact with a side of the second body 120 away from the light-outgoing surface thereof. A side of the second protection part 320 away from the bending protection part 330 is in contact with the adhesive layer 90.

In the present embodiment, a contact surface of the adhesive layer 90 and the second protection part 320 is a third interface 303. The second back plate 620 includes a back plate end surface 304 close to the bent part 130. A distance P2 between the third interface 303 corresponding to the second curved section 212 and the back plate end surface 304 is less than a distance P1 between the third interface 303 corresponding to the first curved section 211 and the back plate end surface 304.

That is, when the display panel 10 is not bent, the distance between the third interface 303 corresponding to the second curved section 212 and the first protection part 310 is less than the distance between the third interface 303 corresponding to the first curved section 211 and the first protection part 310, in the direction from the first protection part 310 to the second protection part 320. Referring to FIG. 10, it is a top view of a first structure of the display module 100 without being bent according to the present disclosure. That is, the distance L2 between the third interface 303 corresponding to the second curved section 212 and the first interface 301 is less than the distance L3 between the third interface 303 corresponding to the first curved section 211 and the first interface 301.

In the present embodiment, with respect to the structures as shown in FIGS. 5 and 6, due to the large variation of the radius of curvature of the cover 20 at the second curved section 212, the bending of the second curved section 212 causes the bent part 130 of the display panel 10 to be subjected to bending forces in both the X-direction and the Y-direction, which in turn causes the bent part 130 of the display panel 10 to be deflected toward the cover 20 to form a special-shaped bending. Referring to FIG. 10, the adhesive layer 90 of the present disclosure is arranged such that the distance between the third interface 303 in the region where the second curved section 212 is located and the first protection part 310 is less than the distance between the third interface 303 in the region where the first curved section 211 is located and the first protection part 310. As the material of the protection layer 30 has a certain leveling distance, the adhesive layer 90 is arranged such that the flow of the material of the protection layer 30 is blocked, and thus the material of the protection layer 30 is stacked close to the adhesive layer 90, thereby increasing the thickness of the second protection part 320. Due to the short distance between the third interface 303 in the region where the second curved section 212 is located and the first protection part 310, the levelling distance of the material of the protection layer 30 enters into the bent part 130, thereby increasing the thickness of the bending protection part 330 close to the second protection part 320, increasing the bending stiffness of the bending protection part 330 close to the second protection part 320, and further improving the supporting force on the bent part 130 in the region, facilitating the curved corners of the bent part 130 to be rounded, alleviating the shape abnormality of the bent part 130 close to the cover 20, improving the force uniformity of the bent part 130, and reducing the risk of line breakage in the display panel 10.

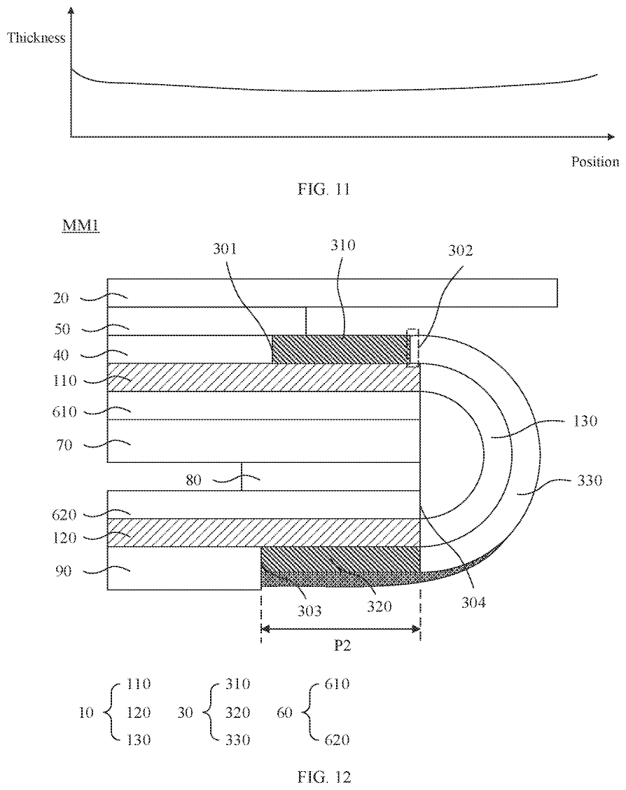

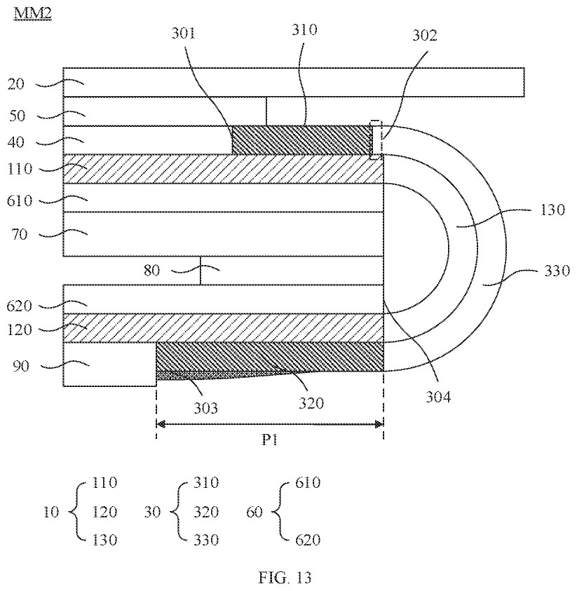

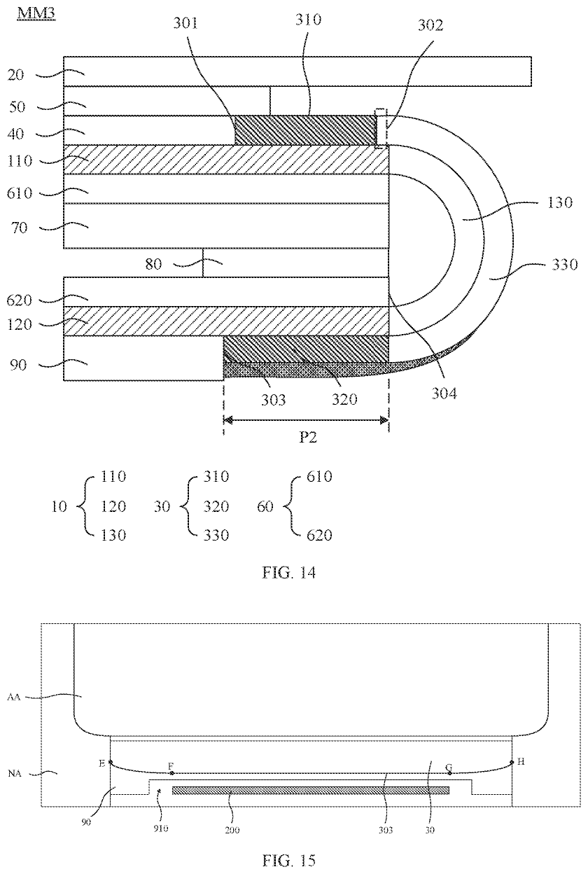

In the display module 100 of the present disclosure, referring to FIGS. 10 to 15, the distance between the third interface 303 and the back plate end surface 304 can be gradually increased in the direction from the second curved section 212 to the first curved section 211. For example, the distances P2 between the third interface 303 and the back plate end surface 304 of FIGS. 12 and 14 are less than the distance P1 between the third interface 303 and the back plate end surface 304 of FIG. 13.

Specifically, referring to FIG. 10, when the display panel 10 is not bent, the distance between the third interface 303 and the first protection part 310 gradually increases in the direction from the second curved section 212 to the first curved section 211, that is, in the X direction. As for the structure of FIG. 5, since the radius of curvature gradually decreases in the direction from point B to the end points C1 and C2 of the cover 20, the display panel 10 is subjected to bending forces that increase gradually in both directions. Therefore, in order to cope with such a change, a side of the adhesive layer 90 close to the second protection part 320 is deformed according to the change in the radius of curvature of the cover 20.

In the present embodiment, since the total amount of coating of the material of the protection layer 30 in any region is the same, the thickness of the second protection part 320 close to the adhesive layer 90 is simultaneously varied as the distance between the third interface 303 and the first protection part 310.

In the present embodiment, the thickness of the second protection part 320 close to the adhesive layer 90 may be negatively related to the distance between the third interface 303 and the back plate end surface 304. Referring specifically to the graph of FIG. 11, since the material of the protection layer 30 has a certain leveling distance, the third interface 303 and the first protection part 310 are spaced apart to determine whether the leveling of the material of the protection layer 30 enters the bent part 130.

For example, in the present embodiment, referring to FIGS. 12 to 14, which are cross-sectional views of sections MM1, MM2, and MM3 in FIG. 10, respectively, and MM1 and MM3 may be symmetrically arranged with MM2.

In FIGS. 12 and 14, the sections MM1 and MM3 are regions corresponding to the second curved sections 212. The bending curvature of the cover 20 is large, and the display panel 10 is subjected to large bending forces in two directions. The adhesive layer 90 has a larger size in a first direction, that is, the distance between the third interface 303 and the first protection part 310 is small, and the material of the protection layer 30 may enter into the curved part after leveling, so that the thickness of the bending protection part 330 close to the second protection part 320 is increased, and the bending stiffness of the bending protection part 330 close to the second protection part 320 is increased to improve the supporting force of the bending protection part 130 at that region, facilitating the tendency of the curved corner of the bent part 130 to be rounded. In addition, more material of the second protection layer 30 may be stacked on the adhesive layer 90, that is, the thickness of the second protection part 320 close to the adhesive layer 90 is relatively large.

Referring to FIG. 13, the section MM2 is an area corresponding to the first curved section 211. The bending curvature of the cover 20 is small, and the display panel 10 is subjected to small bending forces in two directions. The adhesive layer 90 has a small size in the first direction, that is, the distance between the third interface 303 and the first protection part 310 is large. The material of the protection layer 30 does not enter the bent part 130 after leveling, the thickness of the bending protection part 330 close to the second protection part 320 does not change, and the bending stiffness of the bending protection part 330 close to the second protection part 320 does not increase. In addition, less material of the second protection layer 30 may be stacked on the adhesive layer 90, that is, the thickness of the second protection part 320 close to the adhesive layer 90 is small.

Therefore, when the distance between the third interface 303 and the back plate end surface 304 is small, the thickness of the second protection part 320 close to the adhesive layer 90 is large, and the material of the protection layer 30 may enter into the curved part after leveling, thereby increasing the thickness of the bending protection part 330 close to the second protection part 320, and increasing the bending stiffness of the bending protection part 330 close to the second protection part 320. When the distance between the third interface 303 and the back plate end surface 304 is relatively large, the thickness of the second protection part 320 close to the adhesive layer 90 is relatively small, the material of the protection layer 30 does not enter the bent part 130 after leveling, the thickness of the bending protection part 330 close to the second protection part 320 does not change, and the bending stiffness of the bending protection part 330 close to the second protection part 320 does not increase.

In the present embodiment, in the structure of FIGS. 12 and 14, the thickness of a side of the bending protection part 330 close to the second protection part 320 may be greater than the thickness of a side of the bending protection part 330 close to the first protection part 310. That is, due to the blocking effect of the adhesive layer 90, the material of the protection layer 30 extends toward the bending protection part 330, so that the thickness of the side of the bending protection part 330 close to the second protection part 320 increases, thereby increasing the bending stiffness of the side of the bending protection part 330 close to the second protection part 320.

With respect to the structure of FIG. 6, the radius of curvature of the cover 20 is a constant value in the direction from point B to points D1 and D2, the inflection points occur in the radius of curvature at the positions of points D1 and D2, and then the radius of curvature gradually decreases, where the bent part 130 corresponding to the points D1 and D2 is subjected to relatively large bending forces in both directions. Thus, for the structure of the cover 20 in FIG. 6, the curve EH on a side of the adhesive layer 90 close to the second protection part 320 may be the structure in FIG. 15. The curve EH includes line segments EF, FG, and GH. The line segment FG is a straight line segment, and the line segments EF and GH are curve segments. That is, when the radius of curvature of the cover 20 is less than a certain value, the bending force exerted by the cover 20 in both directions on the display panel 10 causes the bent part 130 of the display panel 10 to be bent in an anomalous shape, for example, at points X1 in FIG. 5 and at points X2 in FIG. 6. The corresponding interface on the side of the adhesive layer 90 close to the second protection part 320 may be provided as curve segments, for example, curve segments EF and GH. The arrangement of the curve segments reduces the distance between the third interface 303 and the first protection part 310. The material of the protection layer 30 enters into the bent part 130 after leveling, thereby increasing the thickness of the bending protection part 330 close to the second protection part 320, increasing the bending stiffness of the bending protection part 330 close to the second protection part 320, which in turn improves the supporting force on the bent part 130 at that region, facilitates the curved corner of the bent part 130 to be rounded, alleviates the shape abnormality of the bent part 130 close to the cover 20, improves the uniformity of the force applied to the bent part 130, and reduces the risk of line breakage in the display panel 10.

Therefore, in the present embodiment, when the radius of curvature of the cover 20 is less than a certain threshold value, for example, points X1 in FIG. 5 and points X2 in FIG. 6, the radius of curvature of the cover 20 is positively related to the radius of curvature of the third interface 303 at the corresponding position.

In the display module 100 of the present disclosure, in the structures of FIGS. 12 and 14, the thickness of the second protection part 320 close to the adhesive layer 90 may be less than the thickness of the adhesive layer 90, so as to prevent the material of the protection layer 30 from covering the adhesive layer 90, and to avoid increase of the overall thickness of the display module 100.

In the present embodiment, the material of the adhesive layer 90 may be polyethylene terephthalate (PET).

In the display module 100 of the present disclosure, referring to FIGS. 10 and 15, a groove 910 facing the protection layer 30 is further provided on a side of the adhesive layer 90 away from the protection layer 30. The display module 100 further includes a driver chip 200 disposed in the groove 910.

In the present embodiment, since the adhesive layer 90 is provided to enable the formation of the second protection part 320 with different thicknesses, in order to minimize the waste of the size of the display panel 10, the adhesive layer 90 of the present disclosure is designed as a hollow structure to form the groove in which the driver chip can be accommodated.

In the present embodiment, the adhesive layer 90 is provided in a terminal area of the display module 100, so that the adhesive layer 90 covers the terminal area, thereby effectively avoiding cracking of the elements in the terminal area.

In the present embodiment, the structure of FIGS. 10 and 15 can be applied to the structure of FIG. 7. That is, in the direction away from the polarizer 40, the thickness of the first protection part 310 gradually decreases, and the thickness of the bending protection part 330 is equal at any position, so as to reduce the bending stiffness of the bending protection part 330 close to the first protection part 310, and to make it easier to bend the bent portion 130 at that region. In addition, the adhesive layer 90 is provided on the surface away from the light-outgoing surface of the second body 120, and different curve designs are made on the side of the adhesive layer 90 close to the second protection part 320 according to different bending curvatures of the cover 20, so as to increase the bending stiffness of the bending protection part 330 close to the second protection part 320, increase the supporting force on the bent part 130 at that region, facilitate the curved corner of the bent part 130 to be rounded, and relieve shape abnormality of the bent part 130 close to the cover 20.

The present disclosure further provides a mobile terminal including a terminal body and the display module described above. The terminal body and the display module are integrated with each other. The terminal body may be a component such as a circuit board bonded to the display panel, a cover covering the display panel, or the like. The mobile terminal may include an electronic device such as a mobile phone, a television, and a notebook computer.

It is to be understood by those of ordinary skill in the art that, equivalent substitutions or changes may be made in accordance with the technical solutions of the present disclosure and its inventive concept, and all such changes or substitutions shall fall within the scope of the claims appended hereto.

1. A display module, comprising:
a display panel comprising a first body, a second body, and a bent part disposed between the first body and the second body, the second body being disposed on a side away from a light-outgoing surface of the display panel;
a cover disposed on the display panel, the cover comprising a first curved part corresponding to the bent part, the first curved part comprising a first curved section and second curved sections located at two sides of the first curved section, a minimum bending curvature of the first curved section being less than or equal to a maximum bending curvature of the second curved sections, and the bending curvature of the second curved sections being greater than 0; and
a protection layer disposed on a surface of the display panel, the protection layer comprising a first protection part, a second protection part, and a bending protection part in a continuous arrangement, the first protection part covering a part of the first body, the second protection part covering a part of the second body, and the bending protection part covering the bent part;
wherein a bending stiffness of the bending protection part close to the first protection part is less than that of the bending protection part close to the second protection part.

2. The display module according to claim 1, wherein in a direction from the first protection part to the second protection part, a thickness of the first protection part gradually decreases, and a thickness of a side of the bending protection part close to the first protection part is equal at any position.

3. The display module according to claim 2, further comprising a polarizer disposed on the display panel, wherein a side of the first protection part away from the bending protection part is in contact with the polarizer; and
a thickness of the side of the first protection part away from the bending protection part is greater than a thickness of the polarizer.

4. The display module according to claim 3, wherein the display module further comprises a first back plate disposed on a side of the first body away from a light-outgoing surface thereof; and
the bending protection part comprises a first end close to the first protection part, the first end has an equal thickness at any position, and an orthographic projection of the first end on the first back plate is located in the first back plate.

5. The display module according to claim 4, wherein an interface between the polarizer and the first protection part is a first interface, and a distance between the first interface and the first end is greater than or equal to 250 μm and less than or equal to 500 μm.

6. The display module according to claim 3, wherein the display module further comprises an optical glue layer disposed between the polarizer and the cover, the optical glue layer covers the polarizer and extends between the protection layer and the cover; and
a thickness of the optical glue layer corresponding to the polarizer is greater than a thickness of the optical glue layer corresponding to the protection layer.

7. The display module according to claim 1, wherein the display module further comprises an adhesive layer on a side of the second body away from a light-outgoing surface thereof, and a side of the second protection part away from the bending protection part is in contact with the adhesive layer.

8. The display module according to claim 7, wherein the display module further comprises a first back plate and a second back plate disposed between the first body and the second body, the first back plate is disposed close to the first body, the second back plate is disposed close to the second body, the second back plate comprises a back plate end surface close to the bent part, a contact surface of the adhesive layer and the second protection part is a third interface, and a distance between the third interface corresponding to the second curved sections and the back plate end surface is less than a distance between the third interface corresponding to the first curved section and the back plate end surface.

9. The display module according to claim 8, wherein a distance between the third interface and the back plate end surface gradually increases in a direction from each of the second curved sections to the first curved section.

10. The display module according to claim 9, wherein a thickness of the second protection part close to the adhesive layer is negatively related to the distance between the third interface and the back plate end surface.

11. The display module according to claim 8, wherein a thickness of the second protection part close to the adhesive layer is less than a thickness of the adhesive layer.

12. The display module according to claim 8, wherein a groove facing the protection layer is further provided on a side of the adhesive layer away from the protection layer; and
the display module further comprises a driver chip disposed in the groove.

13. The display module according to claim 8, wherein when a radius of curvature of the cover is less than a threshold value, the radius of curvature of the cover is positively related to a radius of curvature of the third interface at a corresponding position.

14. The display module according to claim 8, wherein a groove is further provided on a side of the adhesive layer away from the protection layer, and a driver chip of the display module is disposed in the groove.

15. The display module according to claim 8, wherein a material of the adhesive layer is polyethylene terephthalate.

16. The display module according to claim 8, wherein the display module further comprises a first support layer and a second support layer disposed between the first back plate and the second back plate, the first support layer is bonded to the first back plate by a glue layer, and the second support layer is bonded to the second back plate by a glue layer.

17. The display module according to claim 16, wherein a material of the first support layer is stainless steel, and a material of the second support layer is foam or polyethylene terephthalate.

18. The display module according to claim 1, wherein a bending curvature of the cover gradually decreases in a direction from the first curved section to each of the second curved sections.

19. The display module according to claim 1, wherein in a direction from the first curved section to each of the second curved sections, the cover comprises a first section and a second section, a bending curvature of the first section is a constant value, and a bending curvature of the second section gradually decreases.

20. A mobile terminal, comprising a terminal body and a display module integrated with each other, wherein the display module comprises:
a display panel comprising a first body, a second body, and a bent part disposed between the first body and the second body, the second body being disposed on a side away from a light-emitting surface of the display panel;
a cover disposed on the display panel, the cover comprising a first curved part corresponding to the bent part, the first curved part comprising a first curved section and second curved sections located at two sides of the first curved section, a minimum bending curvature of the first curved section being less than or equal to a maximum bending curvature of the second curved sections, and the bending curvature of the second curved sections being greater than 0; and
a protection layer disposed on a surface of the display panel, the protection layer comprising a first protection part, a second protection part, and a bending protection part in a continuous arrangement, the first protection part covering a part of the first body, the second protection part covering a part of the second body, and the bending protection part covering the bent part;
wherein a bending stiffness of the bending protection part close to the first protection part is less than that of the bending protection part close to the second protection part.
